(19) United States
(12) Patent Application Publication
(10) Pub. No.: US 2004/0031785 A1
(43) Pub. Date: Feb. 19, 2004

(54) Electrical gridiron utilizing water

(76) Inventor: Omer Muftic, Beverly Hills, CA (US)

Correspondence Address: FULWIDER PATTON LEE & UTECHT, LLP, HOWARD HUGHES CENTER, 6060 CENTER DRIVE, TENTH FLOOR, LOS ANGELES, CA, 90045, US

(21) Appl. No.: 10/266,003

(22) Filed: Oct. 7, 2002

(30) Foreign Application Priority Data
Aug. 19, 2002 (BA) UP-7564/02

(51) Int. Cl. H05B 3/68

(52) U.S. Cl. 219/461.1; 219/450.1; 392/418

(57) ABSTRACT

The electrical gridiron that utilizes water is very small and portable, practical for household and easily maintained, and it could be utilized in an enclosed areas, with optimal temperature grilling and without creating smoke, while it does not allow overheating of food that can create substances harmful to health. Heating elements are placed laterally on the sides of the gridiron away from food juices that drain and could otherwise burn and create smoke which would be partially absorbed by the food being cooked, which is harmful for health. The heating elements radiate heat upwards, preventing excessive evaporation of water from the water container that would otherwise require frequent addition of water. The optimal temperature for grilling is maintained by raising the grilling bars to desirable heights by placing legs of the grilling bars in the provided slots, and if more ventilation is desired, by opening and adjusting a grating plate at the bottom of the gridiron.

### RELATED APPLICATIONS

This application claims priority from Bosnian Patent Application Serial No. UP-7564/02 filed on Aug. 19, 2002.

### BACKGROUND OF THE INVENTION

Most conventional gridirons have to be used outside in an open area because they create smoke and the ones that cause a minimal amount of smoke typically are not practical. There are many different solutions that attempt to prevent smoke forming by separating grease, but because of overheating of food, and in many cases because of directly burned food juices on the gridiron, the results are not desirable.

### SUMMARY OF THE INVENTION

The gridiron of the invention includes laterally installed heating elements placed such that grease from grilled food is not drained on these elements, and the heat from the heating elements is directed upwards, so that water in a container will not evaporate quickly, requiring water to be frequently added into the container which is used in existing gridirons that utilize water. This is very important to point out, because burning of juices from food creates smoke which prevents grilling in enclosed places, and some of this smoke is absorbed by food, which is extremely harmful for health, especially acrolein which is a carcinogen. The use of water increases the humidity of air which prevents drying of food being grilled, and juices from food are not drained on dry surfaces where they would evaporate.

This gridiron is very practical since it is very compact with small dimensions, the grilling bars are very accessible, providing an unobstructed view of grilled food, and allowing grilling in closed areas.

These and other aspects and advantages of the invention will become apparent from the following detailed description and the accompanying drawings, which illustrate by way of example the features of the invention.

### BRIEF DESCRIPTION OF THE DRAWINGS

FIG. 1 shows a drawing of the gridiron in slanted projection.

FIG. 2 shows a cross-section of the gridiron.

FIG. 3 represents longitudinal cross-section of the gridiron.

FIG. 4 shows a container for water.

FIG. 5 represents a section of a wall of the gridiron showing bearings 13 for a stand 6 for grilling bars 5, shown in FIG. 1.

### DETAILED DESCRIPTION OF THE PREFERRED EMBODIMENT

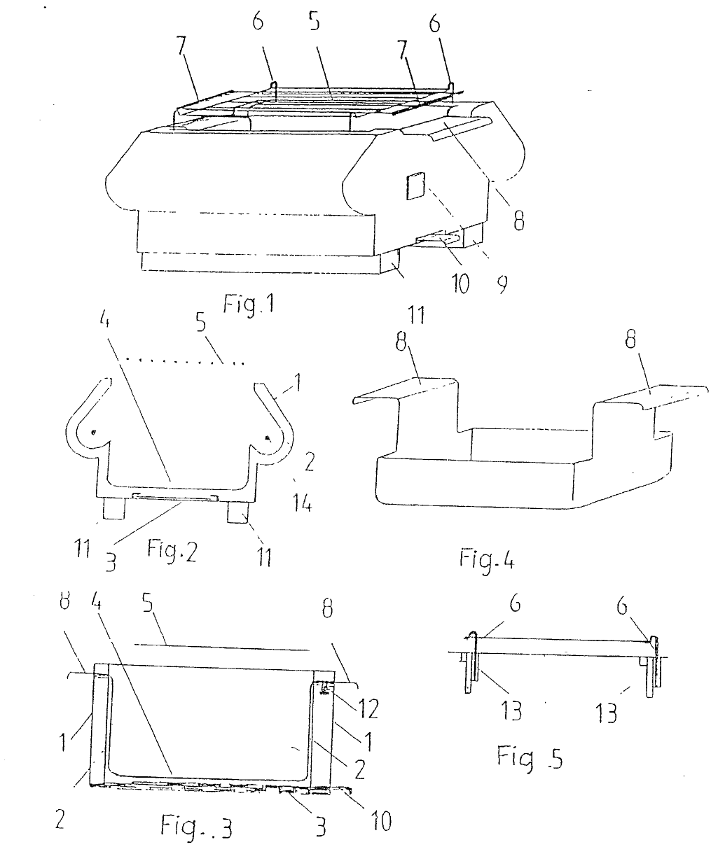

The gridiron typically has a rectangular shape with rounded lateral walls 1, 2 made of stainless steel or enameled material with double walls 1 and 2 except in the location where the water container is placed 4, FIGS. 2, 3 and 4, where the walls of water container replace walls of the gridiron. The inside wall of the rounded lateral part of the gridiron is made of a smooth shiny material so as to reflect heat produced by heating elements 14, shown in FIG. 2, to the grilling bars 5, shown in FIGS. 1, 2 and 3, which has handles 7 and is placed on legs 6 which are bent at their upper end above the grilling bars so that the grease would not drain around them downward. These legs are placed in their provided slots 13, FIG. 5, which are located on the lateral sides of the gridiron and have different depths, so that the grilling bars could be placed at three different heights.

Water container 4, shown in FIGS. 2, 3 and 4, is made of smooth, shiny material, with its front and back walls hanging on the upper rims of the front and back sides of the gridiron in horizontal position 8, which serve also as handles. When there is an insufficient amount of water in water container, there is an elastic spring with a button 12, FIG. 3, which raises the front end of the water container and cuts off electrical power to the gridiron via a switch, which is not shown in the drawings. The lower side of the gridiron has openings for ventilation, and there are two flat grating plates 3, shown in FIGS. 2 and 3, with their openings aligned with the openings on the gridiron, which together can be adjusted to provide a desirable opening. These grating plates on the bottom of the gridiron are very important even though the grilling bars could be raised, providing additional ventilation when a “heating cushion” is formed below the grilling bars when they are completely blocked with food, especially when grilling is performed in an enclosed area and with increased voltage, in order to obtain an optimal temperature for grilling without overheating food and without creating smoke.

The gridiron is stable on its supports 11, shown in FIGS. 1 and 2 and on the front of it there is an electric switch 9, shown in FIG. 1.

### Material to be Used

The electrical gridiron that utilizes water can be made of stainless steel or enameled metal; and grilling bars 5, shown in FIGS. 1, 2 and 3, may be stainless steel with plasticized handles 7, as shown in FIGS. 1, 3 and 4. The heating elements would be made according to regular accepted standards.

It will be apparent from the foregoing that while particular forms of the invention have been illustrated and described, various modifications can be made without departing from the spirit and scope of the invention. Accordingly, it is not intended that the invention be limited, except as by the appended claims.

What is claimed is:

1. An electrical gridiron that utilizes water, comprising:
a housing having rounded lateral walls;
a grill including a plurality of grilling bars, the grill having a plurality of legs placed in a corresponding plurality of slots in the housing;
a water container disposed in the housing;
a plurality of heating elements disposed within the rounded walls of the housing such that heat produced by the plurality of heating elements is reflected by the rounded later walls;
a spring mounted between the water container and the housing biasing the water container to be raised when a level of water in the water container is reduced due to evaporation of water in the water container, and operative to switch off electrical power to the electrical gridiron when the level of water reaches a low point.

2. The electrical gridiron of claim 1, wherein the housing includes a bottom portion having a plurality of openings, and a movable plate having a corresponding plurality of openings that can be moved into and out of alignment with the openings in the bottom portion of the housing to control ventilation of the gridiron.

3. The electrical gridiron of claim 1, wherein said plurality of slots in the housing compromise three sets of slots having first, second and third different depths, respectively, for adjustment of the height of the grill on the electrical gridiron.
